(19) United States
(12) Patent Application Publication
(10) Pub. No.: US 2005/0279317 A1
(43) Pub. Date: Dec. 22, 2005

(54) Reservoir seal with fluid level indicator

(76) Inventors: Jeremy D. Leasure, Jackson, TN (US); Mark W. Wood, Jackson, TN (US); Gary Kreutzer, Jackson, TN (US); John W. Hardin, Medina, TN (US)

Correspondence Address: SUITER WEST SWANTZ PC LLO, 14301 FNB PARKWAY, SUITE 220, OMAHA, NE, 68154, US

(21) Appl. No.: 11/154,020

(22) Filed: Jun. 16, 2005

Related U.S. Application Data
(60) Provisional application No. 60/580,825, filed on Jun. 18, 2004.

(51) Int. Cl. F02F 7/00; F01M 1/00

(52) U.S. Cl. 123/195 R; 123/196 R

(57) ABSTRACT

A mechanical device including a crankcase and reservoir plug suitable for detecting the quantity of lubricant is disclose. In an aspect, the reservoir plug is configured to permit observation of the interior of the plug/crankcase in order to observe the level of contained lubricant. The drain hole for receiving the plug is disposed to encompass the range between the maximum acceptable lubricant level and the minimum acceptable lubricant level. The plug may include a main body portion and transparent portion for permitting observation of fluid, disposed on a second side, from a first side of a sealing interface.

### CROSS REFERENCE

The present application claims priority under 35 U.S.C. §119(e) to U.S. Provisional Patent Ser. No. 60/580,825, entitled: Reservoir Seal With Fluid Level Indicator, filed on Jun. 18, 2004, which is hereby incorporated by reference in its entirety.

### FIELD OF THE INVENTION

The present invention generally relates to compressors and more particularly to a reservoir seal for a lubricated crankcase.

### BACKGROUND OF THE INVENTION

Many mechanical devices include crankcases for housing mechanical components requiring lubrication to minimize wear on the moving components. Lubricant is contained within a sump or a lower portion of the crankcase and thrown or splashed on components, requiring lubrication, during operation. Critical factors in minimizing component wear include ensuring a proper amount of lubricant and preventing lubricant deterioration/contamination with water, particulate matter, and the like. For small engines and mechanical devices such as pumps and oil lubricated air compressors, some users fail to adequately replace lubricant at appropriate intervals to prevent lubricant degradation. As a result, some lubricated components may wear at an accelerated rate over that of a device having fresh lubricant (which has proper lubricity and is essentially free of contaminants). A low lubricant level may also result in increased component wear, thermal brake down of the lubricant, increased component operating temperature, and the like, as a lesser quantity of lubricant is utilized to lubricate moving/heat generating components.

Oiled mechanical devices, e.g., compressors, oiled pumps, small engines (below 20 horsepower, such as a “lawn mower” class engines) and the like proliferate everyday life. Typically, lubricant maintenance is problematic as many devices either do not include any mechanism for checking the condition/quantity of lubricant, or include a dipstick for checking lubrication levels. Dipsticks are often not included due to the complexity/manufacturing difficulty of including the device and the relative infrequency for which lubrication changes may be required. Users often rely on their own knowledge for gauging when to replace/add lubricant.

Therefore, it would be desirable to provide an efficient apparatus configured for permitting user detection of the quantity and/or the condition of lubricant in a crankcase.

### SUMMARY OF THE INVENTION

Accordingly, the present invention is directed to a system and an apparatus for permitting user detection of the quantity and/or the condition of lubricant.

In an aspect of the invention, a mechanical device including a crankcase and reservoir plug suitable for detecting the quantity of lubricant is disclose. In the present aspect, the reservoir plug is configured to permit observation of the interior of the plug/crankcase in order to observe the level of contained lubricant. The drain hole for receiving the plug is disposed to encompass the range between the maximum acceptable lubricant level and the minimum acceptable lubricant level. Preferably, the plug includes a main body portion and transparent portion for permitting observation of fluid, disposed on a second side, from a first side of a sealing interface.

In an additional aspect of the invention, a reservoir plug includes an exemplar, such as a colored segment of the transparent portion, for comparing the status of the lubricant to the minimum acceptable quality of lubricant or lubricant having the maximum acceptable level of degradation (e.g., deterioration of the lubricant itself and/or the maximum acceptable level of contamination).

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a partial isometric view of a compressor in accordance with an aspect of the present invention;

FIG. 2 is an enlarged partial view of a drain plug and crankcase, wherein a generally transparent portion of the drain plug includes an exemplar indicating the characteristics of degraded minimum acceptable lubricant;

FIG. 3 is a partial exploded view of drain plug and crankcase assembly;

FIG. 4 is an isometric view of drain plug including; and

FIG. 5 is an isometric view illustrating a generally obverse view of the drain plug of FIG. 4.

### DETAILED DESCRIPTION OF THE INVENTION

Reference will now be made in detail to the presently preferred embodiments of the invention, examples of which are illustrated in the accompanying drawings.

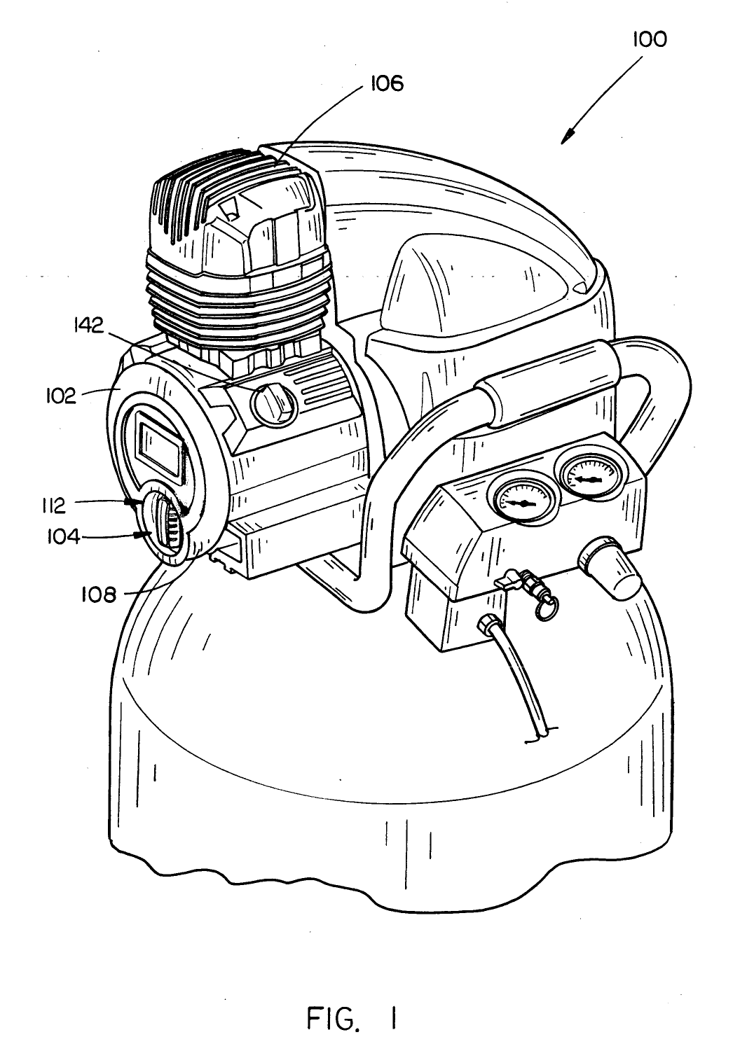

Referring to FIG. 1, in the present embodiment of the invention an oil lubricated air compressor 100 is discussed. In further embodiments, the principles of the present invention may be implemented with a variety of other mechanical devices including engines (in particular small engines under 20 hp (twenty horsepower) or lawnmower-type engines), oiled pumps, and the like wherein efficient lubricant status and quantity determination are desired. For example, the compressor pump, included in the compressor, is a reciprocating piston pump at least partially disposed in a cylinder head for compressing air from a first pressure to a second higher pressure. It is to be appreciated that a wide variety of pump configurations are possible, it is the intent of this disclosure to encompass and include such variation.

A crankcase 102 or other suitable housing is included in the compressor 100. The crankcase 102 is constructed for containing a variety of moving components, such as a crankshaft, an eccentric, piston components, a drive shaft, and the like. The crankcase 102 includes an oil sump 110 or may have an oil sump (i.e., an oil pan) attached to the crank case. In the present embodiment, the lower portion of the crankcase 102, generally below or at least partially below the moving components, is utilized as the oil sump. An oil sump 110 is utilized for containing lubricant for lubricating the various components within the crankcase 102. Typically, the sump is disposed adjacent the bottom or lower region of the crankcase (as may be observed in FIG. 1 or lower in comparison to the moving components encompassed within the crankcase). A drain hole 112 is included in the crankcase 102 for draining lubricant prior to replacement with fresh lubricant. In further embodiments, a separate fill hole and plug system 112 may be included for adding fluid, such as lubricant, to the housing. A drain plug or reservoir seal 104 is included for forming a sealing interface with the crankcase 102. In the present embodiment, the reservoir seal has a circular cross-section and is formed with a generally cylindrical main body portion 128. For example, the main body portion is formed as a generally hollow cylinder with an enclosed end for forming a seal with a crankcase or other housing.

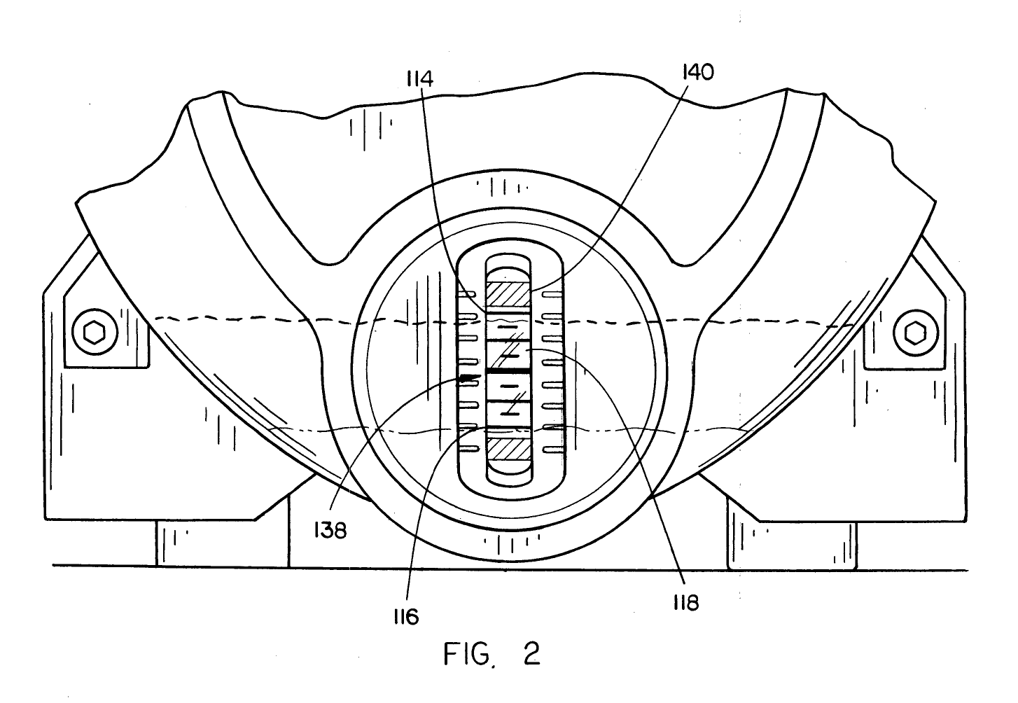

Referring to FIG. 2, a crankcase/crankcase system, i.e., a crankcase and components within the crankcase, a maximum acceptable lubricant level 114 and minimum acceptable lubricant level 116 may be defined, such as based on operating requirement, heat dissipation requirements, and the like factors. For example, the maximum acceptable lubricant level 114 may minimize oil escaping around the piston seal into the cylinder head 106, allow for proper lubrication, and the like. The minimum acceptable lubricant level 116 may permit proper dispersion of lubricant on the various components (e.g., the level of the oil being sufficiently high so that the dipper or disk oil slinger enters the fluid, the entirety of the oil provide sufficient heat dissipation capacity), ensure sufficient lubricant flow within the pool of lubricant, and the like.

During utilization, the lubricant is sprayed, when an oil pump is utilized, or slung, when an oil dipper or disk oil slinger is utilized, onto the moving components in order to reduce friction and to dissipate heat generated by the components. The lubricant may then drip down into the sump 110 to cool and be recycled through the process. Lubricant may become degraded due to thermal brake down or deterioration, contaminated by particulate matter such as dust, foreign particles, water, and the like thereby degrading (lubricant deterioration/contamination) the capability of the lubricant to prevent wear.

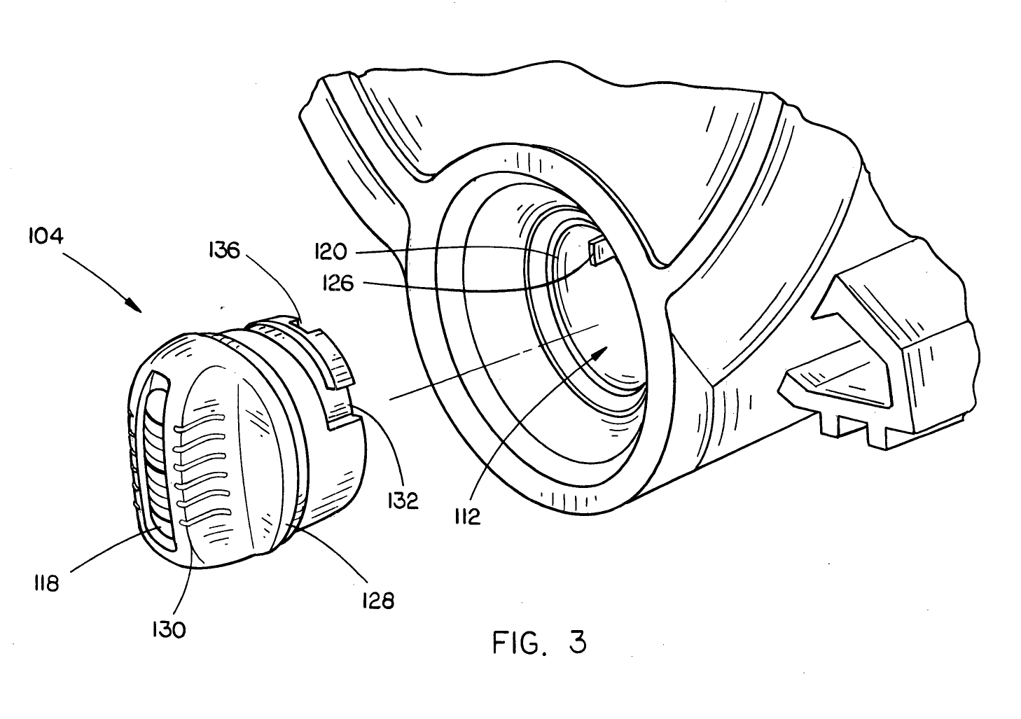

Preferably, the drain hole 112 is disposed, and is of sufficient size, in order for the opening to encompass both the maximum and minimum acceptable lubricant level range. In the foregoing manner, when the reservoir seal 104, or drain plug, of the present invention is utilized a user may observe both the maximum and minimum acceptable oil levels. In the current embodiment, the aperture is circular with the center point of the opening disposed midway, or equal distance from the maximum acceptable lubricant level 114 and the minimum acceptable lubricant level 116. Centering the aperture at the midpoint between the maximum and minimum lubricant levels 114 and 116, respectively, may permit symmetrical orientation of the plug 104. For example, as may be best observed in FIGS. 3-5, the plug 104 and/or lip or wall of the crankcase forming the aperture is configured to permit orientation in approximately 180° (one hundred eighty degrees) offset orientation. In this manner, a transparent portion of the drain plug 118 may be constructed so the drain plug appears to be in the same orientation while permitting efficient “twisting” or spiral engagement of the plug 104.

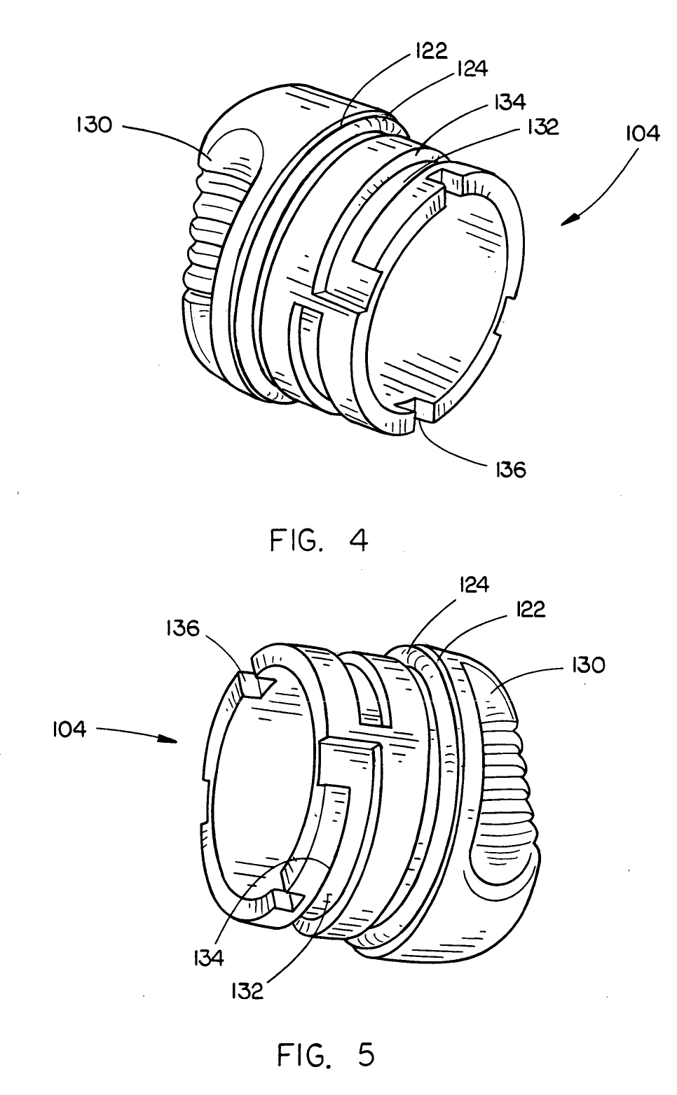

Referring to FIGS. 3-5, in an embodiment, the plug 104 and the crankcase lip 120 are configured with a corresponding slot/tab system constructed to permit efficient engagement and orientation of the drain plug 104. In other embodiments, the drain plug/crankcase are formed with corresponding threading. Referring to FIGS. 4 and 5, in the current embodiment, two opposing slots/tabs, which may be offset by approximately 180° (one hundred eighty degrees), are included to provide for generally equal sealing across a sealing interface formed by a flange or flange extension 122, included on the main body of the plug, and an O-ring 124 contacting the lip 120 of the crankcase. Preferably, the groove system is formed in the plug 104 and the tab 126 is formed in the crankcase lip 120 for ease of manufacture. For example, the slot is formed generally in an L-shape with the circumferential segment of the L-shape groove 132 having an inclined or angled sidewall to allow for frictional engagement between the walls forming the groove and the tab. A two slot/tab system may allow for two opposing orientations which permits the transparent 118 or at least partially transparent portion of the plug to be orientated perpendicular to the maximum and minimum acceptable lubricant levels (so the transparent portion is aligned with gravity when the mechanical device is in a normal operating position). Other configurations may be implemented as well to permit efficient orientation of the plug as desired. It is the intention of this disclosure to encompass and include such variation. An aperture or recess may be included in the main body portion to permit venting of lubricant which is within the plug. For example, two opposing venting notches (one is referenced) 136 are included in a curved sidewall of the main body portion for maintaining equilibrium between the lubricant level in the transparent portion 118 and the level of the overall fluid in the housing. In embodiments, the venting notches are sized to prevent inadvertent engagement of the vent notch with a tab 126 formed in the crankcase. For example, the venting notches 136 are of a size significantly smaller than the entrance portion of the L-shaped groove 132 to prevent difficulty in assembly of the drain plug 104 to the crankcase 102. Those of skill in the art will appreciate the shape and/or location of a vent may be varied based on design preferences, to prevent inadvertent engagement, and the like.

With continued reference to FIGS. 3-5, in the present embodiment, the main body portion 128 of the plug includes a protrusion or other structure constructed for hand manipulation. For example, the protrusion is an elongate protrusion 130 extending along a diameter of the main body portion 128. In other embodiments, a knob-shaped protrusion is included in the main body portion for aiding grasping. Grasping aids such as surface texturing, ribs/grooves, and the like may be included for aiding in removal/securing of the drain plug. Including an elongate protrusion may permit an elongate transparent or semi-transparent window, generally extending the diameter of the crankcase aperture/the plug, to be formed. Furthermore, the elongate protrusion may be contoured to be grasped between a user's forefinger and thumb. In the present embodiment, the transparent portion is formed of a plastic material and may be co-molded with the main body portion. In further examples, the transparent portion may be formed of a separate piece which is adhesively secured to the main body portion, the transparent portion may also be a preformed structure around which the main body is molded.

In the present embodiment, the transparent portion 118 is shaped as a site-glass having a partial cylindrical shape which at least partially extends outwardly from the plug to allow observation from a wider range of angles. For example, the transparent portion is constructed as a curve form at least partially extending from the elongate protrusion 130. In the current example, the transparent portion is of a length at least equal to or greater than the range between the maximum acceptable fluid level 114 and the minimum acceptable fluid level 116. The transparent portion may be shaped as desired for the particular system. Inclusion of a transparent portion may permit observation of the lubricant within the crankcase from a first side of a sealing interface formed by the drain plug to a second side on which lubricant or other fluid is contained. For example, a sealing interface may be formed by the main body portion of the plug, the transparent portion and an O-ring, disposed adjacent a flange or washer, for aiding in fluid isolation/retention.

Suitable indicators or markings may be included on the transparent portion and/or adjacent the transparent portion (e.g., on the main body portion of the plug or on the crankcase adjacent the drain hole) for indicating a condition such as the level of the fluid or the extent to which a fluid such as a lubricant has degraded. Suitable markings include coated markings, etchings, printed markings, stickers, structures formed integrally within the transparent portion, and the like. For example, a series of indicia lines or graduations 138 may be printed on the transparent portion. Additionally, other information may be provided in a similar manner on the transparent portion or on the plug. For example, instructions such as “Maximum”, “Minimum”, “Change” and the like may be provided in a substantially similar manner.

In a further aspect of the invention, an exemplar, or example, of the maximum acceptable level of lubricant degradation is provided as part of the transparent portion or the main body portion. Lubricant degradation or the changing in the lubricity of the material may be caused by deterioration of the oil/lubricant itself, such as through thermal brake down, contamination by water, dust, debris, and the like. Typically, hydrocarbon based lubricant may change color due to the introduction of contaminates, deterioration, and the like. For example, oil may change from a light brown slightly transparent color to a dark brown or black color which is somewhat opaque as degradation occurs. In the present embodiment, a portion of the transparent portion, the main body portion, or an area adjacent may be color coded to the maximum acceptable level of degradation. For instance, a first end of the transparent portion is of a brown color approximately matching the color at which the lubricant will no longer effectively lubricate the moving components. In this manner, a user may observe that the lubricant matches the colored or tinted portions and recognize a lubricant change is appropriate. In another example, the graduations are of a color generally matching the maximum acceptable level of degradation such that a portion of the graduations “disappear” when the lubricant is ready to be changed.

It is believed that the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

1. A mechanical device, comprising:
a crankcase constructed to contain moving components, the crankcase defining an interior including a sump for containing lubricant, the crankcase additionally defining an aperture extending through the crankcase into the crankcase sump; and
a plug constructed to engage with the crankcase to substantially seal the crankcase aperture, the plug including a generally transparent portion configured to permit observation of at least a portion of an interior of at least one of the plug or the crankcase,
wherein the crankcase aperture is located to encompass a maximum acceptable lubricant level and a minimum acceptable lubricant level for the crankcase.

2. The mechanical device of claim 1, further comprising a pump for compressing air from a first pressure to a second higher pressure.

3. The mechanical device of claim 1, wherein the plug is configured for threaded engagement with the crankcase.

4. The mechanical device of claim 1, wherein the plug is provided with a first indicia and a second indicia.

5. The mechanical device of claim 4, wherein the plug is a generally circular plug having a center point located generally midway between the maximum acceptable lubricant level and the minimum acceptable lubricant level for the crankcase.

6. The mechanical device of claim 1, wherein the plug includes a medial elongate protrusion configured to permit hand manipulation of the plug.

7. The mechanical device of claim 6, wherein the generally transparent portion of the plug is located along the medial elongate protrusion.

8. The mechanical device of claim 1, wherein the plug and the crankcase adjacent the crankcase aperture include corresponding tab and spiral grooves for orientating the plug in two generally opposing orientations offset by approximately 180° (one hundred eighty degrees).

9. The mechanical device of claim 1, wherein the plug defines a site glass chamber in fluid communication with the interior of the crankcase.

10. The mechanical device of claim 1, wherein at least one of the plug or the crankcase defines a slot having an inclined surface for frictionally securing the plug and the crankcase.

11. The mechanical device of claim 1, wherein at least a portion of the plug is colored to form an exemplar approximately matching the maximum acceptable lubricant degradation.

12. A drain plug, comprising:
a generally cylindrical main body portion including a flange defining a sealing interface; and
a generally transparent portion included within the main body portion, the generally transparent portion being configured to permit observation from a first side of the sealing interface to a second side of the sealing interface,
wherein at least one of the generally cylindrical main body portion or the generally transparent portion include a first indicia and a second indicia.

13. The drain plug of claim 12, wherein the flange is an outwardly extending radial flange and the first indicia and the second indicia are symmetrically disposed with respect to a center point of the flange.

14. The drain plug of claim 12, wherein the generally cylindrical main body portion is at least partially threaded.

15. The drain plug of claim 12, wherein the generally cylindrical main body portion includes a medial elongate protrusion configured to permit hand manipulation of the plug.

16. The drain plug of claim 15, wherein the generally transparent portion is located along the medial elongate protrusion.

17. The drain plug of claim 12, wherein the generally cylindrical main body portion is at least one of co-molded with the transparent portion or includes a transparent portion adhesively secured to the main body portion.

18. The drain plug of claim 12, wherein the generally cylindrical main body portion defines at least one of a tab or a slot having an inclined surface for frictionally securing the plug.

19. The drain plug of claim 12, wherein the generally cylindrical main body portion at least partially defines a site glass chamber having at least two fluid communication apertures.

20. The drain plug of claim 12, wherein at least a portion of the generally cylindrical main body portion or the generally transparent portion is colored to form an exemplar approximately matching the maximum acceptable lubricant degradation.

21. A drain plug for a mechanical device, comprising:
a main body for forming a seal with a housing; and
means for at least partially observing fluid contained within the housing for which the drain plug is configured engage.

22. The drain plug of claim 21, wherein the main body portion includes a medial protrusion configured to permit hand manipulation of the drain plug.

23. The drain plug of claim 21, wherein the main body portion is at least partially threaded.

24. The drain plug of claim 21, further comprising means for judging the degradation of a fluid.
